(19) United States
(12) Patent Application Publication
(10) Pub. No.: US 2024/0238886 A1
(43) Pub. Date: Jul. 18, 2024

(54) THREAD CLAMPING DEVICE

(71) Applicant: Saurer Spinning Solutions GmbH & Co. KG, Übach-Palenberg (DE)

(72) Inventors: Michael Jakob, Regensburg (DE); Josef Winter, Winterbach (DE)

(73) Assignee: Saurer Spinning Solutions GmbH & Co. KG, Übach-Palenberg (DE)

(21) Appl. No.: 18/557,130

(22) PCT Filed: Apr. 26, 2022
(86) PCT No.: PCT/EP2022/060994

§ 371 Date: Oct. 25, 2023

(30) Foreign Application Priority Data
Apr. 28, 2021 (DE) 102021110888.8

(51) Int. Cl. B23G 1/26

(52) U.S. Cl. CPC B23G 1/26

(57) ABSTRACT

A thread clamping device for a spindle for detachably securing a thread in a clamping gap, comprising a first clamping unit with an inner casing that can be arranged coaxially to the spindle, a thread separator that can be secured in an axial direction on the inner casing, the first clamping unit being securable on an upper part of the spindle for axial positioning, and a second clamping unit having a clamping element that can be adjusted axially relative to the first clamping unit between a clamping position closing the clamping gap between the thread separator and the clamping element and an open position opening the clamping gap. The thread separator is designed to be secured on the spindle upper part for axial positioning and to be rotationally coupled to the spindle upper part, and the thread separator and the inner casing can be rotationally coupled to one another.

The invention relates to a thread clamping device for a spindle of a spinning or twisting machine for releasably fixing a thread in a clamping gap, comprising:
a first clamping unit, having an inner sleeve, which can be arranged coaxial with the spindle, and having a thread cutter, which can be fixed on the inner sleeve in the axial direction, which first clamping unit can be fixed on an upper part of the spindle such that axial positioning is provided; and
a second clamping unit, having a clamping element, which can be moved axially, relative to the first clamping unit, between a clamping position, in which the clamping gap between the thread cutter and the clamping element is closed, and an open position, in which the clamping gap is open.

Thread clamping devices of the aforementioned type are known in a variety of embodiments from the prior art, for example from DE 10 2011 076 744 A1. By means of such thread clamping devices, the so-called wrapping thread can be fixed during the exchanging of a full thread package at a spinning or twisting machine.

For this purpose, the thread clamping devices generally have a first and a second clamping unit attached to a rotatable upper part of a spinning or twisting spindle. The first clamping unit has, for example, an inner sleeve, which is attached to the rotatable upper part of the spinning or twisting spindle for conjoint rotation, and a thread cutter, which lies on an end face at one end of the inner sleeve, the other end of the inner sleeve being fixed on the upper part of the spinning or twisting spindle in order to secure the axial position of the inner sleeve. In contrast, the second clamping element, for example an outer sleeve arranged coaxial with the inner sleeve, is mounted for movement in the axial direction relative to the rotatable upper part of the spinning or twisting spindle and relative to the first clamping unit and is held in a clamping position by means of a spring up to a certain rotational speed of the spinning or twisting spindle, in which clamping position the clamping gap between the thread cutter and the second clamping element is closed.

The second clamping element is designed such that, in the clamping position, without an application of centrifugal force as a result of rotation of the upper part of the spinning twisting spindle, the second clamping element fixes the thread in the clamping gap. In contrast, under the influence of centrifugal forces the second clamping element is axially moved toward the open position, in which a thread fixed in the clamping gap is released.

In known thread clamping devices, the region of connection of the upper part of the spinning or twisting spindle for connecting to the inner sleeve of the first clamping unit for conjoint rotation has a knurled portion. During the mounting, the knurled portion cuts into the inner sleeve, whereby a positive connection effective in the circumferential direction is established between the inner sleeve and the upper part of the spinning or twisting spindle. However, the knurled portion of the upper part of the spinning or twisting spindle places high demands on the manufacturing of the spinning or twisting spindle. If, for example, the edges of the knurled portion are not sufficiently sharp, they do not properly cut into the plastic of the inner sleeve when the inner sleeve is mounted on the upper part of the spinning or twisting spindle. As a result, a material displacement process occurs instead, in which process the inner sleeve is pressed radially outward and thus the outside diameter of the inner sleeve increases in some parts. This can cause undesired friction between the inner sleeve and the clamping element, which is axially movable relative to the inner sleeve, and this friction can lead to blocking and thus to a failure of the thread clamping device.

Alternatively, DE 10 2011 076 744 A1 already discloses providing the inside of the inner sleeve with a toothed annular surface for engaging in a corresponding contour of the spindle upper part. This solution similarly places high demands on the manufacture of both the inner sleeve and the spindle upper part. If the toothing is inaccurate, the inner sleeve can again be subjected to material displacement, which presses the inner sleeve radially outward.

Proceeding therefrom, the invention addresses the problem of providing a thread clamping device which easily and reliably allows the inner sleeve to be connected to the spindle of the spinning or twisting machine for conjoint rotation.

The invention solves the problem by means of a thread clamping device having the features of claim 1. Advantageous further developments of the invention are stated in the dependent claims.

The thread clamping device according to the present invention has a first and a second clamping unit. The first clamping unit comprises an inner sleeve, which can be arranged coaxial with the spindle, and a thread cutter, which can be fixed on the inner sleeve in the axial direction, and the first clamping unit can be fixed on an upper part of the spindle such that axial positioning is provided. The second clamping unit is equipped with a clamping element, which can be moved axially, relative to the first clamping unit, between a clamping position, in which the clamping gap between the thread cutter and the clamping element is closed, and an open position, in which the clamping gap is open. The second clamping unit can have a common design known from the prior art. Thus, the clamping element of the second clamping unit can be designed, for example, as a single-piece or multi-piece outer sleeve which is supported by the inner sleeve for movement relative to the inner sleeve. For this purpose, the inner sleeve and the outer sleeve or the clamping element can have, on the inside or outside thereof, corresponding, operatively interconnectable or interconnected support means and movement means. The term “support means” can refer, merely as an example, to projections and recesses which can be brought into engagement with each other and which are correspondingly formed on the inner sleeve and on the clamping element so that guided movement of the clamping element relative to the inner sleeve can be brought about. The movement means can preferably be formed by a common centrifugal-force unit having a plurality of centrifugal-force elements, which are mounted between the inner sleeve and the clamping element such that the clamping element can be moved relative to the inner sleeve, in accordance with the rotational speed of the spindle, in order to open and close the clamping gap accordingly.

The thread clamping device according to the invention is characterised in that the thread cutter is designed to be fixed on the upper part of the spindle such that axial positioning is provided and to be connected to the spindle upper part for conjoint rotation, and in that the thread cutter and the inner sleeve can be connected to each other for conjoint rotation. In order to arrange the thread clamping device on a spindle upper part of a spinning or twisting machine, the inner sleeve of the first clamping unit is slid onto the upper part of the spindle. In the direction in which the inner sleeve is slid on, the axial position of the inner sleeve can be fixed preferably by means of a corresponding design of the spindle, e.g. by means of a projection or shoulder, against which the end face of one end of the inner sleeve can placed. According to the invention, the thread cutter is used to secure the axial position of the inner sleeve against the direction in which the inner sleeve is slid onto the spindle, which thread cutter, fixed on the spindle in the axial direction, is operatively connected to the other end of the inner sleeve.

According to the present invention, the thread cutter is used not only to secure the axial position of the inner sleeve but also for connecting the inner sleeve to the spindle for conjoint rotation, for which purpose the thread cutter can be connected at least to the inner sleeve for conjoint rotation and preferably also to the spindle upper part for conjoint rotation. Accordingly, the thread cutter is used not only to axially position the inner sleeve on the spindle upper part at least against the direction in which the inner sleeve is slid on but also to connect the inner sleeve to the spindle for conjoint rotation; the thread cutter, in its position on the spindle upper part in which the thread cutter axially positions the inner sleeve, brings about the first clamping unit and also the connection to the spindle upper part for conjoint rotation. Because the thread cutter can be connected to the inner sleeve for conjoint rotation in this position of the thread cutter, a connection of the inner sleeve to the spindle upper part for conjoint rotation is achieved, and thus a separate design of the spindle in the region of connection to the inner sleeve for connection for conjoint rotation is rendered unnecessary.

The thread clamping device thus allows particularly easy and reliable mounting of the inner sleeve on the spindle upper part for conjoint rotation, while malfunction-causing deformation of the inner sleeve, for example in interaction with connecting elements on the spindle upper part, is effectively avoided. The thread clamping device according to the present invention allows the thread clamping device to be particularly easily and economically connected to the spindle.

In principle, the connection of the thread cutter to the spindle upper part for conjoint rotation can be in any form; for example, positive connections can be used, in the case of which the securing for conjoint rotation between the spindle upper part and the thread cutter is achieved by means of specific shaping. According to a preferred embodiment of the invention, the thread cutter can be pressed onto the spindle upper part.

According to this embodiment of the invention, the thread cutter is designed such that, when the thread clamping device is in its mounted position on the spindle, the thread cutter is connected to the spindle upper part for conjoint rotation by means of a press-fit connection. The press-fit connection is designed such that it ensures not only reliable positioning of the inner sleeve in the axial direction of the spindle at least against the direction in which the inner sleeve is slid on, but also the securing of the inner sleeve for conjoint rotation with the spindle. The press-fit connection between the spindle and the thread cutter can be produced particularly easily and economically.

According to a preferred embodiment of the invention, it is provided that, for the connection of the thread cutter to the inner sleeve for conjoint rotation, the thread cutter can be frictionally, integrally and/or positively connected to the inner sleeve for conjoint rotation. A frictional connection can be produced, for example, by means of a suitable design of the surfaces of the thread cutter and of the inner sleeve which can be brought into contact with each other, reliable securing for conjoint rotation being ensured by the contact force and by the friction between the surfaces. An integral connection can be established by means of adhesive bonding, for example.

According to a preferred further development of the invention, it is provided that, in order to produce a positive connection, the thread cutter has engagement elements, which can be brought into engagement with a contact portion on the inner sleeve, more particularly can be pressed into the contact portion. In this embodiment of the invention, the thread cutter is designed, in the region of contact with the inner sleeve, such that engagement elements on the thread cutter press into the inner sleeve in defined locations before or during the mounting of the thread clamping device on the spindle, whereby a positive connection between the inner sleeve and the thread cutter is produced. This preferred embodiment of the invention allows the inner sleeve to be particularly reliably and easily arranged on the spindle for conjoint rotation and essentially without play. Furthermore, the preferred design of the thread cutter results in fixing of the first clamping unit on the spindle upper part both in and against the direction in which the inner sleeve is slid on, such that axial positioning is provided. In this preferred embodiment, elements for fixing the inner sleeve in the direction in which the inner sleeve is slid on are definitely no longer required on the spindle upper part or on the spindle itself.

The engagement elements can particularly preferably be pressed into the contact portion of the inner sleeve in order to clamp the inner sleeve on the spindle upper part, said contact portion being made of a material that can be deformed by the application of force. For example, selected engagement elements or all engagement elements on the thread cutter can be dimensioned such that, during the mounting of the thread clamping device on the spindle, the engagement elements press into the contact portion of the inner sleeve— which contact portion is made, for example, of a plastic-containing material— in such a way that material displacement toward the centre of the inner sleeve occurs, resulting in a reduction of the inside diameter of the inner sleeve at the corresponding material displacement points, whereby a clamping force which clamps the inner sleeve onto the spindle upper part is brought about. The thread cutter can preferably be made of a metal-containing material in general so that in particular the engagement elements can be pressed into the contact portion of the inner sleeve more reliably and more easily especially in this preferred embodiment. In a departure from common turning processes, the thread cutter made of metal-containing material can particularly preferably be produced by means of a sintering process. Thus, polygonal engagement elements in particular can be formed extremely precisely on the thread cutter. The first clamping unit can thus be easily and reliably fixed on the spindle upper part both in the circumferential direction and in the axial direction without the need for any additional fixing elements on the inner sleeve and/or on the spindle upper part. The inside diameter of the inner sleeve is preferably selected in accordance with the outside diameter of the spindle upper part such that the inside diameter of the inner sleeve allows the inner sleeve to be slid onto the spindle upper part and allows the clamping effect resulting from the pressing in of the engagement elements.

According to an additional preferred embodiment of the invention, the contact portion on the inner sleeve has coupling elements, which can be brought into operative connection with the engagement elements. In this embodiment of the invention, coupling elements matched to the shape of the engagement elements on the thread cutter are provided in the contact portion of the inner sleeve, which coupling elements positively interact, in the circumferential direction, with the corresponding engagement elements— such that a reliable connection for conjoint rotation is ensured— when the thread clamping device is mounted on the spindle. The engagement elements and the coupling elements can particularly preferably be in the form of toothing allowing particularly reliable axial positioning of the inner sleeve— for conjoint rotation— by means of the thread cutter, both in the axial direction and in the circumferential direction.

According to an additional preferred embodiment of the invention, a connecting element is arranged in the region between the contact portion and the thread cutter and is designed to be frictionally and/or positively connected to the contact portion and to the thread cutter for conjoint rotation. In this preferred embodiment of the invention, the connecting element is used as an adapter element which can be connected, in the axial direction, both to the thread cutter and to the contact portion of the inner sleeve for conjoint rotation. The use of a connecting element thus allows the thread cutter and the inner sleeve to be interconnected for conjoint rotation regardless of their design in the region of connection. The connecting element is used as an adapter which frictionally and/or positively interconnects at least the thread cutter and the inner sleeve in the circumferential direction so that the thread cutter and the contact portion do not have to be matched to each other.

The connecting element can also preferably be designed to fix the first clamping unit on the spindle upper part axially and for conjoint rotation by means of clamping or an interference fit.

The connecting element can preferably be arrangeable on the spindle upper part with a press fit and/or can have engagement elements, as described above, for producing a clamping effect with the spindle upper part by means of material displacement of the thread cutter and/or of the contact portion during the mounting of the thread clamping device. Alternatively, the operative connection between the thread cutter and the connecting element and/or between the contact portion of the inner sleeve and the connecting element can be such that the connecting element can be subjected to material displacement as described above, as a result of the provision of corresponding engagement elements on the thread cutter and/or on the contact portion, in order to clamp the first clamping unit on the spindle upper part. The component having the material displacement, or a corresponding component portion, is made of a material that can be deformed by the application of force, for example a plastic-containing material. As described above, the inside diameter should be set in accordance with the outside diameter of the spindle upper part such that the clamping effect or the interference fit or the press fit can be produced by means of the material displacement.

According to a preferred embodiment of the invention, the connecting element is in the form of an adhesion ring or toothed ring, which can particularly reliably ensure a frictional and/or positive connection for conjoint rotation, the adhesion ring providing a sufficient friction torque and the toothed ring ensuring a reliable positive connection.

In a departure from what was previously known, the thread cutter can also preferably be produced from a metal-containing material by means of a sintering process, whereby in particular the polygonal shape can be formed more precisely.

Embodiment examples of the invention are explained below with reference to the drawings. In the drawings:

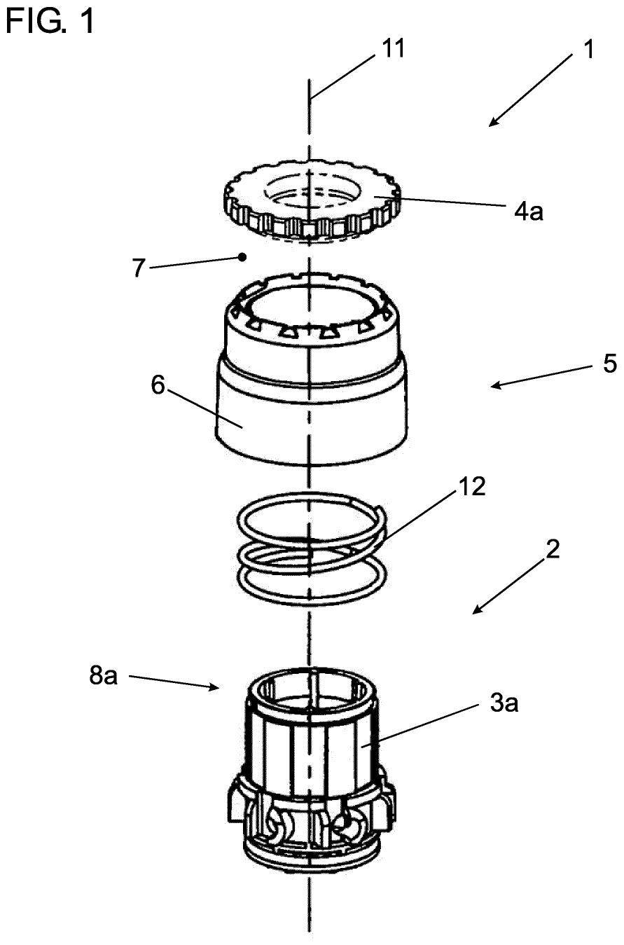

FIG. 1 shows a schematic illustration of an exploded view of a thread clamping device according to one embodiment;

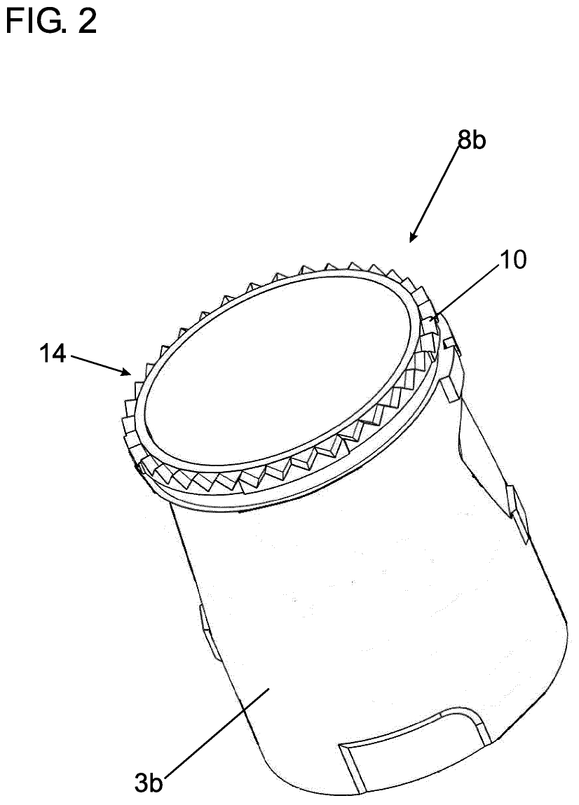

FIG. 2 shows a perspective schematic view of an additional embodiment example of an inner sleeve of a thread clamping device;

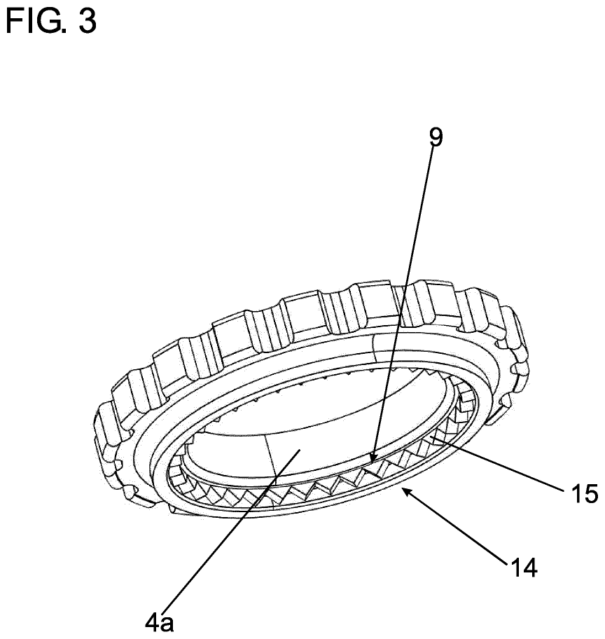

FIG. 3 shows a perspective schematic view of a thread cutter of the thread clamping device of FIG. 1;

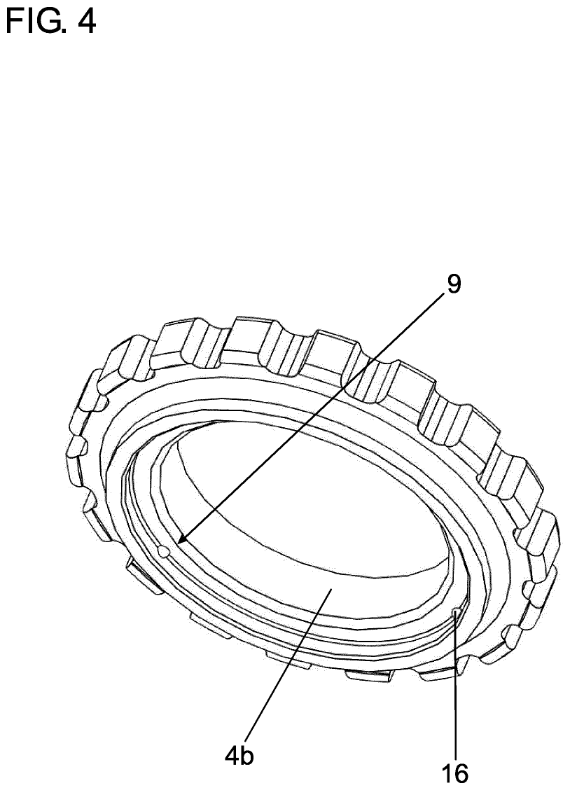

FIG. 4 shows a perspective schematic illustration of an additional embodiment example of a thread cutter; and

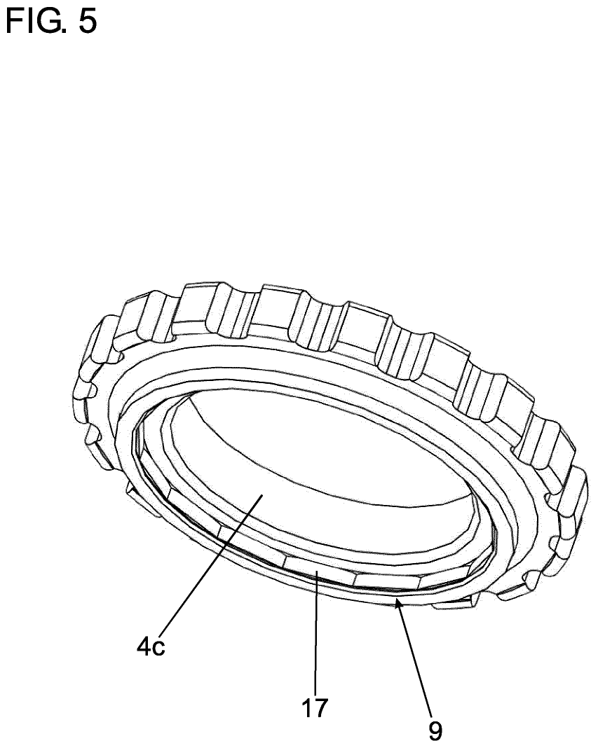

FIG. 5 shows a perspective schematic view of an additional embodiment example of a thread cutter.

The thread clamping device 1 shown in FIG. 1, for clamping a thread at an upper part of a spindle (not shown here), more particularly in a spinning or twisting machine (also not shown here), comprises an inner sleeve 3a of a first clamping unit 2, which inner sleeve 3a can be arranged for conjoint rotation with respect to the upper part of the spindle. In addition to the inner sleeve 3a, the first clamping unit 2 also has a thread cutter 4a, which can be pressed onto the upper part of the spindle and which fixes the thread clamping device 1 in the axial direction, opposite to the direction in which the thread clamping device 1 is slid onto the upper part of the spindle.

In order to connect the inner sleeve 3a to the spindle upper part for conjoint rotation, the thread cutter 4a, which can be pressed onto the spindle upper part for conjoint rotation, is provided with coaxially peripherally arranged engagement elements 9 in the form of teeth 15 in the region of contact with the inner sleeve 3a (see FIG. 3).

When the thread clamping device 1 is mounted on the spindle upper part, the teeth 15 press into an end face of the contact portion 8a of the inner sleeve 3a and cause material displacement of the contact portion 8a toward the centre of the inner sleeve such that the inner sleeve is clamped on the spindle upper part axially and for conjoint rotation, thus ensuring that the inner sleeve 3a is arranged on the spindle upper part for conjoint rotation. According to an additional embodiment example, the thread cutter 4a can be alternatively or additionally arranged on the spindle upper part, for conjoint rotation and with axial fixation, by means of a press fit.

A clamping element 6, which can be moved in the axial direction relative to the inner sleeve 3a, is arranged coaxial with the inner sleeve 3a. The clamping element 6 forms an outer sleeve, which can be slid onto the inner sleeve 3a, and the clamping element 6 can be moved, in a known way, relative to the inner sleeve 3a and to the thread cutter 4a along the longitudinal axis 11. The surfaces of the thread cutter 4a and of the clamping element 6 which face each other form a clamping gap 7 of the thread clamping device 1, in which clamping gap 7 the thread can be clamped at the spindle. According to this embodiment example, the axially movable clamping element 6 is mounted on the inner sleeve 3a under axial preload by means of a helical compression spring 12 such that, when the spindle is in the rest position, the clamping element 6 is arranged in the clamping position, in which the clamping element 6 is in contact with the thread cutter 4a. For the automated movement of the clamping element 6 toward the open position, in which the thread is released, the thread clamping device 1 has, in a known way, a centrifugal-force unit (not shown here), the centrifugal-force mechanism of which comprises a plurality of centrifugal-force elements, which space the axially movable clamping element 6 from the thread cutter 4a as soon as the spindle rotates at a certain minimum rotational speed, whereby the clamping gap 7 is opened and a thread arranged in the clamping gap 7 is released.

FIG. 2 shows a schematically simplified illustration of an additional embodiment example of an inner sleeve 3b, which has, in the contact portion 8b, coaxial peripheral toothing 14 composed of a plurality of coupling elements 10, for connection to the thread cutter 4a shown in FIG. 3 for conjoint rotation. The design of the toothing 14 on the inner sleeve 3b is matched to the design of the toothing 14 of the thread cutter 4a shown in FIG. 3 so that a reliable connection for conjoint rotation between the thread cutter 4a and the inner sleeve 3b is ensured when the thread clamping device 1 is in its mounted position on the spindle upper part.

FIG. 4 shows an additional embodiment example of a thread cutter 4b in which the coupling elements 9 are formed by sphere portions 16, which press into the contact portion 8a of the inner sleeve 3a during the mounting of the first clamping unit 2 and thus ensure a connection for conjoint rotation by means of the thread cutter 4b, which is arranged on the spindle upper part for conjoint rotation.

FIG. 5 shows an additional embodiment example of a thread cutter 4c, in which the engagement elements 9 for connection to the inner sleeve 3a for conjoint rotation are formed by a plurality of protrusions 17, which follow one another in the circumferential direction and which form a polygonal contact surface, which contact surface establishes a connection to the contact portion 8a of the inner sleeve 3a, said connection being positive in the circumferential direction.

### LIST OF REFERENCE SIGNS

1 Thread clamping device
2 First clamping unit
3a, 3b Inner sleeve
4a, 4b, 4c Thread cutter
5 Second clamping unit
6 Clamping element
7 Clamping gap
8a, 8b Contact portion
9 Engagement element
10 Coupling element
11 Longitudinal axis
12 Helical compression spring
13 Sealing element
14 Toothing
15 Tooth
16 Sphere portions
17 Protrusions

1. A thread clamping device for a spindle of a spinning or twisting machine for releasably fixing a thread in a clamping gap, comprising:
a first clamping unit, having an inner sleeve, which can be arranged coaxial with the spindle, and having a thread cutter, which can be fixed on the inner sleeve in an axial direction, the first clamping unit can be fixed on an upper part of the spindle such that axial positioning is provided; and
a second clamping unit, having a clamping element, which can be moved axially, relative to the first clamping unit, between a clamping position, in which the clamping gap between the thread cutter and the clamping element is closed, and an open position, in which the clamping gap is open;
wherein the thread cutter is designed to be fixed on the spindle upper part such that axial positioning is provided and is designed to be connected to the spindle upper part for conjoint rotation; and
wherein the thread cutter and the inner sleeve can be connected to each other for conjoint rotation.

2. The thread clamping device according to claim 1, wherein the thread cutter can be pressed onto the spindle upper part.

3. The thread clamping device according to claim 1, wherein the thread cutter can be frictionally, integrally and/or positively connected to the inner sleeve for conjoint rotation.

4. The thread clamping device according to claim 1, wherein the thread cutter is formed from a metal-containing material by a sintering process.

5. The thread clamping device according to claim 1, wherein the thread cutter has engagement elements, which can be brought into engagement with a contact portion on the inner sleeve.

6. The thread clamping device according to claim 5, wherein the engagement elements can be pressed into the contact portion in order to clamp the inner sleeve on the spindle upper part, the contact portion being made of a deformable material.

7. The thread clamping device according to claim 45, wherein the contact portion has coupling elements, which can be brought into operative connection with the engagement elements.

8. The thread clamping device according to claim 5, wherein the engagement elements are in the form of toothing.

9. The thread clamping device according to claim 5, further including a connecting element which is arranged in a region between the contact portion and the thread cutter and is frictionally and/or positively connected to the contact portion and to the thread cutter for conjoint rotation.

10. The thread clamping device according to claim 9, wherein the connecting element comprises an adhesion ring or toothed ring.
